(19) United States
(12) Patent Application Publication
(10) Pub. No.: US 2008/0289830 A1
(43) Pub. Date: Nov. 27, 2008

(54) Roof-top fire prevention sprinkler system with storage rack

(76) Inventor: Eric Olson, Orlando, FL (US)

Correspondence Address: ELSIE C. TURNER, 201 PARK PLACE, SUITE 204, ALTAMONTE SPRINGS, FL, 32701, US

(21) Appl. No.: 12/072,247

(22) Filed: Feb. 26, 2008

Related U.S. Application Data
(60) Provisional application No. 60/931,643, filed on May 24, 2007.

(51) Int. Cl. A62C 3/00

(52) U.S. Cl. 169/16; 239/280; 239/208

(57) ABSTRACT

A roof-top fire prevention sprinkler system, with or without an optional, separate storage rack, is comprised of a rotating sprinkler head mounted on a support frame of conduit having fluid communication between a water source and the sprinkler head. The frame, having a more or less rectangular shape bent in the middle of the long sides, saddles the peak of a roof to be protected. At the bend in the frame, at the roof peak, a cross piece of conduit bisects the long sides of the rectangle, and is in fluid communication therewith. The sprinkler head is connected to the middle of the cross piece. Water can be supplied through a garden hose connected to a pipe extension of stiff conduit which is in turn connected to one of the short sides of the rectangle. The pipe extension can act as a pole to place or retrieve the support frame at or from the roof peak without the user having to climb onto the roof. Cylindrical pliant rollers surrounding the short sides of the rectangle allow the frame to glide easily up a sloping side of a pitched roof. The optional storage rack can hold the sprinkler and frame, disconnected from the pipe extension, on end against a wall, taking up little space when not in use.

### RELATED U.S. APPLICATIONS

U.S. Provisional Application Ser. No. 60/931643, filed May 24, 2007, of which the Applicant claims the benefit.

### FIELD OF THE INVENTION

This invention relates to the field of sprinkler systems designed to protect buildings, particularly residences, from being set afire from flying embers of wildfires.

### BACKGROUND OF THE INVENTION

Interior sprinkler systems to prevent the spread of interior files have long been commonplace in hotels, public and private buildings, and some residences. However, sprinkler systems to prevent the ignition of exterior residential roofing by wildfire embers are limited in number. An external fire prevention system is disclosed in U.S. Pat. No. 5,263,543 to Nigro. It comprises a length of straight water supply conduit installed along the roof peak of a house, provided with nozzles or sprinklers disposed in fixed space-apart relationship along the conduit, and connected to a water source controlled by an automatic activation including a smoke detector and solenoid valves for activation and shutoff and complex electric circuitry. The disclosure of this system in the patent suggests that it would be a more or less permanent installation, cumbersome, time-consuming and labor intensive to install or uninstall.

U.S. Pat. No. 6,360,968 to Orrange is for a wildfire protection system which, like Nigro, has spaced apart sprinklers, simple nozzles dispersing in a 360° pattern, disposed along a straight water supply conduit, but is removably disposed along the roof peak or peaks of a house so that it can be removed for sprinkler irrigation or disassembled for storage. The conduit can be supplied with water by connecting to a garden hose. The sprinklers are saddled on the roof peak with half of the sprinkler legs resting on one side of the peak and the remaining legs on the opposite side. This system has no automatic control feature. The system is light weight but vulnerable to displacement in windy conditions, thus anchor-weighting with sandbags or water containers on sprinkler footings. The water container weights depicted in the drawings have bowed ends which would facilitate sliding across the roof parallel to the roof ridge and conduit but do not appear to facilitate any motion 90° to the roof ridge, i.e. up or down the roof slope. Although this system is intended to be removable and taken apart, disassembly would be time-consuming and cumbersome. Another disadvantage of a multiple nozzle design supplied from a single conduit is that the water pressure diminishes along the line, the nozzle closest to the water supply having the highest pressure while the nozzle at the distal end has the least pressure and thus the least projection.

Accordingly, there is a need for a simpler sprinkler system with fewer elements which can be quickly installed or removed and which can be deployed easily by rolling it from the edge of a roof up the roof slope to the peak and which is weighted in place by the water supplied to the sprinkler heads rather than by separate water containers. It is also advantageous to utilize a rotating sprinkler head which can project water within a larger perimeter than a stationary nozzle system.

### SUMMARY OF THE INVENTION

A roof-top fire prevention sprinkler system, with or without an optional, separate storage rack, is comprised of a rotating sprinkler head mounted on a support frame of conduit having fluid communication between a water source and the sprinkler head. The frame, having a more or less rectangular shape bent in the middle of the long sides, saddles the peak of a roof to be protected. At the bend in the frame, at the roof peak, a cross piece of conduit bisects the long sides of the rectangle, and is in fluid communication therewith. The sprinkler head is connected to the middle of the cross piece. Water can be supplied through a garden hose connected to a pipe extension of stiff conduit which is in turn connected to one of the short sides of the rectangle. The pipe extension can act as a pole to place or retrieve the support frame at or from the roof peak without the user having to climb onto the roof. Cylindrical pliant rollers surrounding the short sides of the rectangle allow the frame to glide easily up a sloping side of a pitched roof. The optional storage rack can hold the sprinkler and frame, disconnected from the pipe extension, on end against a wall, taking up little space when not in use.

### BRIEF DESCRIPTION OF THE DRAWINGS

FIG. 1 is a perspective view of the sprinkler system in the process of being moved into position at the peak of a pitched roof;

FIG. 2 is a perspective view of the sprinkler system in place on the peak of a pitched roof;

FIG. 3 is a detail perspective view of the sprinkler system without its pipe extension for connection to a water hose;

FIG. 4 shows the sprinkler system hanging on its storage rack;

FIG. 5 is a perspective view of a commercially available pulsating two pattern sprinkler head modified in accordance with this invention;

FIG. 6 is a partial perspective view of an alternative modification to the sprinkler head of FIG. 5;

FIG. 7 is a partial perspective view of an unmodified commercially available two-pattern sprinkler head.

### DETAILED DESCRIPTION OF THE PREFERRED EMBODIMENT

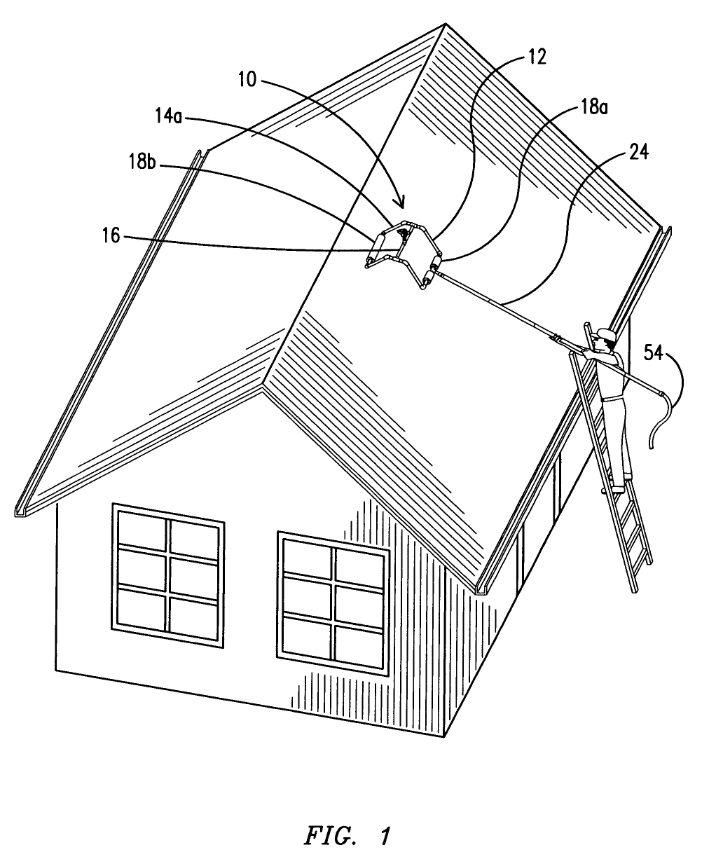

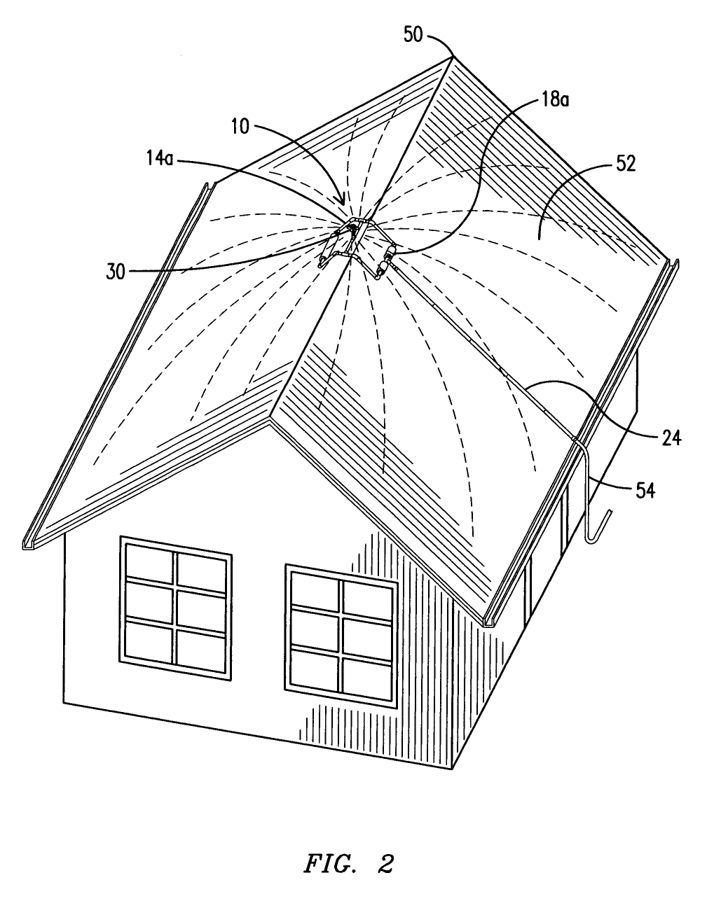

Referring to FIGS. 1, 2 and 3, the sprinkler system 10 of this invention has a support frame 12 in the shape of a bent rectangle formed of substantially rigid pipe, such as PVC pipe, its two long sides 14a and b intersected at midpoint with an additional piece of conduit, center pipe 16, parallel to its two short sides 18a and b. All conduit is shown as pieces of straight pipe joined by appropriately shaped couplings 17 selected to achieve the humped shape of the rectangle and to permit communicating water flow throughout frame 12. Sprinkler head 30, preferably rotating, is connected to the midpoint of center pipe 16, for reasons which ensue further below. Center pipe 16 is intended to sit parallel to and on top of the peak 50 of a pitched roof 52, so that the sprinkler head 30 can deliver water to both sides of the roof 52. The bent configuration of the frame 12 allows it to rest stably, like a saddle, astride the peak 50. For maximum effective distribution of water from the sprinkler system, it should be placed equidistant from each end of the roof peak 52. The sprinkler head 30 should be at the midpoint of center pipe 16 so that water pressure from each end of the pipe is equalized.

One of the short sides 18a is intersected at midpoint with a T-shaped coupling 22 having a threaded member 23 for removably connecting a pipe extension 24. When stored with pipe extension 24 disconnected, as in FIG. 3, a threaded cap 25 for threaded member 23 is provided to keep out roaches, lizards, and other insects which could clog the sprinkler head 30. As with all the pipe in the sprinkler system 10, pipe extension 24 is substantially rigid, thus enabling the user to use it as a pole to place the sprinkler system 10 astride the roof peak 50 from a ladder without getting upon the roof itself. The opposite end of pipe extension 24 is threaded for connection to an ordinary garden hose 54. Sprinkler head 30 is preferably a pulsating two-pattern impact design available commercially from L. R. Nelson Corporation or Rain Bird Corporation, powered by water pressure alone.

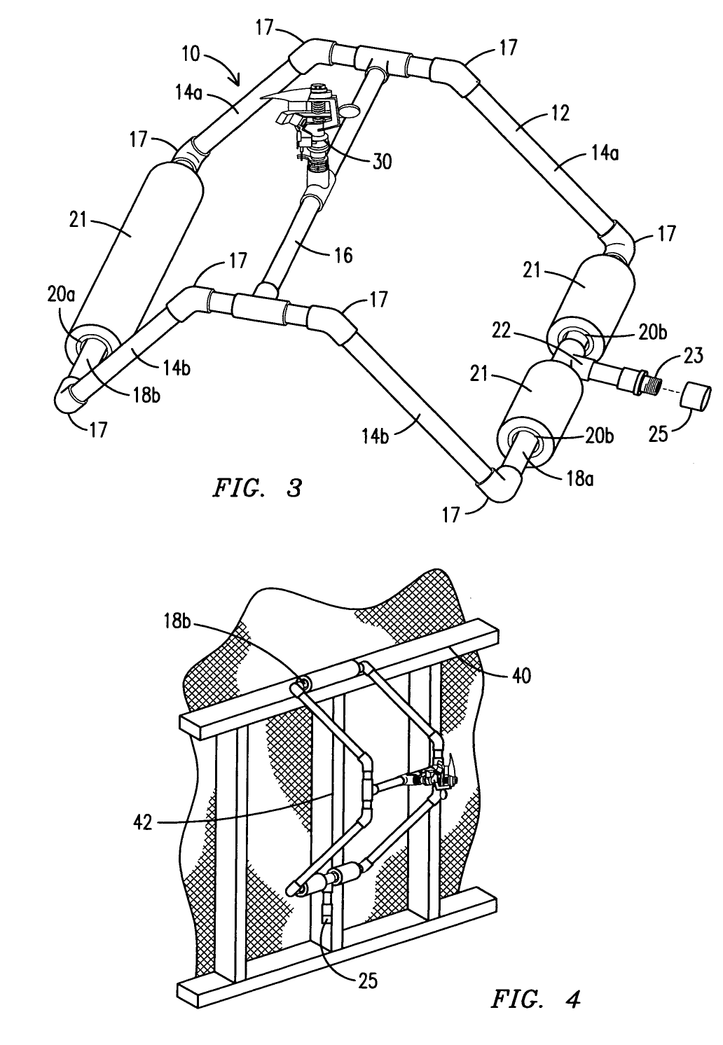

As shown in FIGS. 3 and 4, both short sides 18a and b are fitted with cylindrical rollers 20a and b to facilitate sliding the sprinkler system 10 upward upon a shingled roof. These rollers could be made of PVC pipe in a larger diameter than that of pipes 18 a and b and sheathed with heavy-duty foam pipe insulation 21.

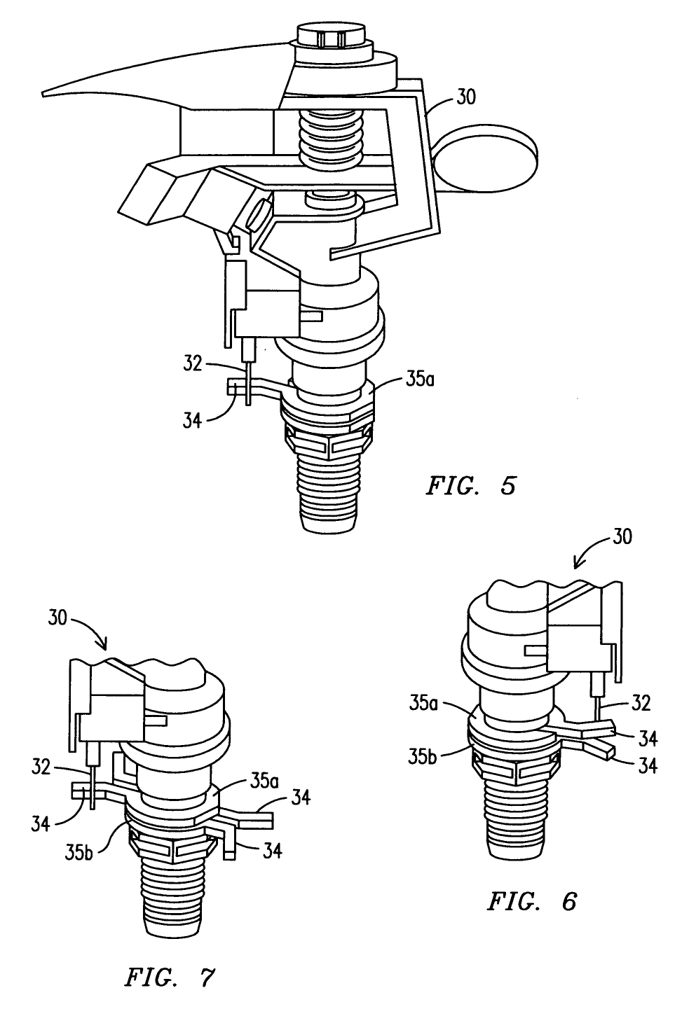

Referring now to FIGS. 5, 6 and 7, sprinkler head 30 is typical of the kind that rotates first in one direction, sprinkling water in an outer circular pattern until trip 32 makes contact with a stop 34. It then reverses direction and sprinkles in an inner circular pattern. In FIG. 7, the unaltered version of the sprinkler head has two pairs of stops 34, one pair per mounting ring 35a and 35b. The two stops 34 on each ring are mirror images of each other. These stops may be positioned so as to limit the sprinkling patterns to partial circles or arcs of varying degree. However since the object of this invention is to provide 360° coverage, some of the stops are removed in FIGS. 5 and 6. In FIG. 5, all but one stop is removed. In FIG. 6, one stop 34 has been removed from each ring, 35 a and 35b, and the remaining stops 34 have been arranged one above the other, so that the head 30 will rotate in essentially the same patterns as it would in FIG. 5

A simple storage rack 40 is shown in FIG. 4 which allows the sprinkler system 10 to hang sideways from its short pipe 18b, thus taking up little floor space in a storage area. Side 18a rests against vertical strut 42, which prevents gravitational pull from rotating the device off the rack 40.

It is understood that while certain forms of the present invention have been illustrated and described herein, it is not to be limited to the specific forms or arrangements of parts described and shown. For instance, the flame could be made of any conduit suitable for water. If copper tubing were to be selected, some of the couplings could be eliminated. The bent rectangle shape of the frame could be somewhat different, with rounded corners, as long as it could straddle the roof peak 52 with stability, positioning the sprinkler head 30 for equal distribution of water on both sides of the roof 50.

What is claimed is:

1. A roof-top fire prevention sprinkler system comprising:
At least one rotating sprinkler head supported by a frame of conduit for removable placement atop the roof of a building, said frame having fluid communication with said sprinkler head and having a coupling for attachment of a water supply member.

2. The sprinkler system of claim 1, wherein said frame is shaped to sit astride the peak of a pitched roof, and said sprinkler head is positioned vertically over said peak.

3. The sprinkler system according to claim 2, wherein said frame has opposing sides positioned on opposing slopes of said roof, said sides being equipped with rollers to facilitate sliding movement over said roof.

4. The sprinkler system according to claim 3, wherein said water supply member comprises a rigid pipe removably connectible to said coupling, whereby said sprinkler system may be pushed into a position astride said peak of said roof or retrieved therefrom,

5. The sprinkler system according to claim 4, said water supply member further comprising a garden hose connected between said rigid pipe and a source of water.

6. The sprinkler system according to claim 5 wherein said frame of conduit has the shape of a rectangle with its long sides bent in the middle thereof to form a saddle configuration with opposing sides positioned on opposing slopes of said peak of said roof.

7. The sprinkler system according to claim 6, further comprising a storage rack for hanging said frame and sprinkler head against a wall when not in use.

8. A roof-top fire prevention sprinkler system comprising:
At least one rotating sprinkler head supported by a frame of conduit for removable placement atop the roof of a building, said frame having fluid communication with said sprinkler head and having a coupling for attachment of a water supply member, said frame having a bent shape so as to sit astride the peak of a pitched roof, and further comprising opposing sides positioned on opposing slopes of said peak, said sides equipped with rollers, and said frame having a center section of conduit parallel to and on top of said peak, said center section having a midpoint in fluid communication with said sprinkler head, said sprinkler system further comprising a rigid water pipe removably connected to said coupling, whereby said sprinkler system may be pushed up a sloping side of said pitched roof to said peak, or retrieved therefrom.

9. The sprinkler system according to claim 8 further comprising a storage rack for hanging said frame and sprinkler head, disengaged from said water supply member, against a wall.
